(19) United States
(12) Patent Application Publication
(10) Pub. No.: US 2009/0195873 A1
(43) Pub. Date: Aug. 6, 2009

(54) THREE-DIMENSIONAL IMAGE REPRODUCING APPARATUS

(75) Inventor: Takashi Kubara, Fukuoka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/355,095

(22) Filed: Jan. 16, 2009

(30) Foreign Application Priority Data
Jan. 17, 2008 (JP) P2008-007712

(51) Int. Cl. G02B 27/22; G02B 5/32

(52) U.S. Cl. 359/463; 359/20

(57) ABSTRACT

The invention provides a three-dimensional image reproducing apparatus that enables stable provision of a three-dimensional image display by preventing occurrence of crosstalk between adjacent lenses or adjacent hologram optical elements and eliminating shift of a three-dimensional image. The three-dimensional image reproduce apparatus of the invention includes an array of adjacent optical elements, which is an array of lenticular lens, an fly-eye lens array and an array of hologram optical elements, and a cross-talk prevent part preventing cross-talk between the adjacent optical elements and having an image source providing a plurality of images each of which has a different parallax information.

### BACKGROUND OF THE INVENTION

The present invention relates to a three-dimensional image reproducing apparatus that reproduces a stereographic image by use of a lenticular lens array, a fly-eye lens array, or a hologram optical element.

A parallel-vision random dot stereogram method under which a right-side stereographic image including binocular parallax is viewed with a right eye and which a left-side stereographic image including binocular parallax is viewed with a left eye, a stereoscope method under which a view is acquired by use of eyeglasses with a liquid-crystal shutter or by using one lens for a right eye and another lens for a left eye, and an anaglyph method under which a red binocular parallax picture and a blue binocular parallax picture, both of which differ from each other in only color, are viewed by use of red-and-blue eyeglasses, and other methods, have been known as methods for displaying three-dimensional image information since old times. However, when a three-dimensional image is viewed under these methods, special training or special eyeglasses are necessary.

By virtue of development of a liquid crystal technique, liquid crystal displays providing a three-dimensional display without eyeglasses are recently released one after another. Most of the displays are three-dimensional liquid crystal displays of image splitter type without eyeglasses. Specifically, the three-dimensional liquid crystal display without eyeglasses produces three-dimensional effect by periodically arranging the image optical paths toward the liquid crystal display to right and left eye of an observer. That is, such display divides and periodically arranges the horizontally adjacent pixels of liquid crystal display to right and left eye of an observer by a parallax barrier or a lenticular lens and the like.

Thus, the three-dimensional liquid crystal display device without eyeglasses is a three-dimensional image display device having only horizontal parallax. Images supplied to the positions of the left and right eyes of the observer include horizontal parallax attributable to the parallax barrier or the lenticular lens array. Hence, the display device in principle involves a problem of loss of a stereoscopic effect when the positions of the right and left eyes of the observer deviate from the horizontal direction.

Therefore, in a three-dimensional image display device including a combination of a liquid crystal display panel and a parallax barrier or a lenticular lens array, if an attempt is made to acquire stereoscopic vision with a stereoscopic effect of a three-dimensional movies or pictures for a long period of time, it is necessary to spatially fix the positions of the right and left eyes in place.

In relation to horizontal deviation in the positions of the right and left eyes, the method for correcting and controlling the image optical paths in accordance with the deviation by monitoring the position of eyes and/or face of an observer by a sensor. However, the method entails a large-scale apparatus and inconvenience of equipping an observer with a marker to sense the positions of eyes and the position of a face.

As a method enables to provide a three-dimensional display of image independent from the position of eyes, the method which is extension of integral photography method after M. G. Lippmann in 1908 has been proposed. This proposed three-dimensional display method uses a two-dimensional display panel such as liquid crystal display substituting for a film, a pin hole and fly-eye lens array (a fly-eye shaped convex lens array). This method is, for example, described in JP-2001-275134.

The above mentioned integral photography proposed by M. G. Lippmann reproduces a three-dimensional image by following method. At first, a film is placed at the position of a focal point of the fly-eye lens array. Then images of respective convex lenses (fly-eye lenses) of the fly-eye lens array are recorded on the film. During reproducing operation, the images from the respective convex lenses of the fly-eye lens array recorded on the film is reproduced by passing the images through the same fly-eye lens array as that used in recording the images on the film in the opposite direction.

Incidentally, an optical structure required to perform stereogram with naked eye includes an image splitter method, a lenticular method, and integral photography.

Under the image splitter method, in order to display a left-eye image at the position of the left eye and a right-eye image at the position of the right eye, optical slits are provided so as to prevent the left eye from viewing the image for right-eye and the right eye from viewing the image for left-eye. Further, under the lenticular method, the right-eye image and the left-eye image are arranged in the form of a strip by means of respective convex lenses (semicylindrical cylindrical lenses) of the lenticular lens array, and the positions of images are set according to an image-forming equation (1/f=1/a+1/b). Under integral photography, an image including a plurality of parallaxes is positioned below a lenticular lens array, a fly-eye lens array, and a pin hole and rendered so as to project the image in a parallax direction.

However, the optical configuration required to perform conventional stereograph with naked eye has a problem of cross-talk between lenses. When the eyes of an observer laterally move from observation position, the parallax image can be seen at some level. However, when movement of the eyes exceeds a certain area, a parallax image of the adjacent lens is observed. This fact causes the cross-talk between lenses.

When crosstalk arises between lenses, an image to be originally displayed by the next lens or slit is displayed; hence, an image becomes distorted or shifted. For this reason, crosstalk greatly affects quality of a stereoscopic display.

As a countermeasure against the problem, an attempt has been made to geometrically make it difficult to form an image of display data from the next lens by use of a lens having a short focal length, to thus diminish the crosstalk. In order to achieve a short focal length in an optical system having a simple structure, a reduction in the curvature radius of a lens is effective. However, it is very difficult to efficiently manufacture a lens array having a small curvature radius.

Another attempt is also made to optically insulate lenses one from another by use of a shield mask. However, there arises a problem of a reproduced three-dimensional image becoming dark and three-dimensional reproduction being hindered by a contour effect of the shield mask. The same also applies to a case where a stereoscopic image is reproduced by use of a hologram optical element.

### SUMMARY OF THE INVENTION

The present invention has been conceived in light of the above problems and aims at providing a three-dimensional image reproducing apparatus that enables stable provision of a three-dimensional image display by preventing crosstalk between adjacent lenses or adjacent hologram optical elements and eliminating shift of a three-dimensional image when a stereoscopic image is reproduced by use of a lenticular lens array, a fly-eye lens array, or a hologram optical element.

In order to achieve the foregoing object, the present invention provides a three-dimensional image reproducing apparatus including an array of adjacent optical elements, which is an array of lenticular lens, an fly-eye lens array and an array of hologram optical elements, and a cross-talk prevent part preventing cross-talk between the adjacent optical elements and having an image source providing a plurality of images each of which has a different parallax information.

According to the first aspect of the invention, the cross-talk prevent part includes a plurality of images each of which has a different parallax information provided on a focus plane of the array so that a polarized characters of a ray from each of the images are different from each other in order that the ray passes through corresponding one of the optical elements, and a polarizing plate provided on an emitting side of the optical elements and having a polarized character which is different on the adjacent optical elements and same on the next adjacent optical elements.

According to the present invention, occurrence of crosstalk between adjacent lenses or adjacent hologram optical elements can be prevented. Thus, an image that should not originally be displayed is not displayed on the adjacent lens or the adjacent hologram optical element. As a consequence, distortion or shift of an image is prevented. Therefore, there is yielded an advantage of the ability to implement a three-dimensional image reproducing apparatus capable of providing a stable stereoscopic image, enhanced image quality of a three-dimensional image display, and an enhanced stereoscopic effect.

### BRIEF DESCRIPTION OF THE DRAWINGS

FIG. 1 is a view showing a configuration for preventing occurrence of crosstalk by utilization of a difference in polarizing characteristic; namely, the principal part of a three-dimensional image reproducing apparatus of a first embodiment of the present invention;

FIG. 2 is a view for describing the principle of integral photography;

FIG. 3 is a view for describing crosstalk from an adjacent lens in the lenticular lens array;

FIG. 4 is a view for describing the principle of operation for displaying a crosstalk-free image on a target lenticular lens in the three-dimensional image reproducing apparatus shown in FIG. 1;

FIG. 5 is a view showing a configuration that prevents occurrence of crosstalk by use of two plane-convex lenses; namely, the principal part of a three-dimensional image reproducing apparatus of a second embodiment of the present invention;

FIG. 6 is a view showing a configuration that prevents occurrence of crosstalk by use of an integrated waveguide; namely, the principal part of a three-dimensional image reproducing apparatus of a third embodiment of the present invention;

FIG. 7 is a view showing a configuration that prevents occurrence of crosstalk by use of a microlens; namely, the principal part of a three-dimensional image reproducing apparatus of a fourth embodiment of the present invention;

FIG. 8 is a view showing a configuration that prevents occurrence of crosstalk by placing convex lenses at entrance ends of respective lenses or optical elements; namely, the principal part of a three-dimensional image reproducing apparatus of a fifth embodiment of the present invention;

FIG. 9 is a view showing a configuration that prevents occurrence of crosstalk by placing a hologram surface in a common input optical path to a lens array or a common input optical path to all optical elements; namely, the principal part of a three-dimensional image reproducing apparatus of a sixth embodiment of the present invention;

FIG. 10 is a view showing a configuration that prevents occurrence of crosstalk by placing a light source that generates light rays in equal number to parallaxes at a focal point on a quadratic surface of a sculptured surface; namely, the principal part or a three-dimensional image reproducing apparatus of a seventh embodiment of the present invention;

FIG. 11 is a view showing a configuration that prevents occurrence of crosstalk by provision of a transparent spatial modulator that modules light projected by a quadratic surface in a parallax direction by means of information about an image to be displayed and that allows passage of the modulated light; namely, the principal part of a three-dimensional image reproducing apparatus of an eighth embodiment of the present invention; and

FIG. 12 is a view showing a configuration that prevents occurrence of crosstalk by use of a relay optical system that spatially projects an image once formed by an optical system; namely, the principal part of a three-dimensional image reproducing apparatus of a ninth embodiment of the present invention.

### DETAIL DESCRIPTION OF PREFERRED EMBODIMENT

The present invention can be applied to a display method, such as integral photography, a lenticular method, a parallax barrier method, and an ultra-multiple lens method, and the like, which enables provision of stereogram display with naked eye by combination of two-dimensional image information including parallax information, a lenticular lens array, a slit-shaped barrier such as liquid crystal, and a fly-eye lens or a hologram optical element. A preferred embodiment of a three-dimensional image reproducing apparatus of the present invention will be described hereunder in detail by reference to the drawings. Respective embodiments illustrate the case of use of a lens array. However, the same also applies to the case of use of a hologram optical element.

### First Embodiment

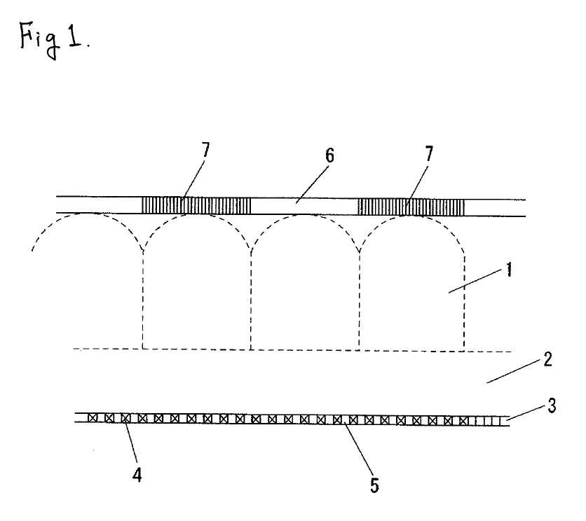

FIG. 1 is a view showing a configuration for preventing crosstalk by a difference in polarizing characteristic; namely, the principal part of a three-dimensional image reproducing apparatus of a first embodiment of the present invention. In the first embodiment, a configuration for preventing crosstalk between adjacent lenses is described.

Specifically, the first embodiment shows a configuration for preventing a crosstalk between adjacent lenses. In the configuration, a plurality of images each of which has a different parallax information provided on a focus plane of the array of lenses so that a polarized characters of a ray from each of the images are different from each other in order that the ray passes through corresponding one of the optical elements, and a polarizing plate provided on an emitting side of the optical elements and having a polarized character which is different on the adjacent optical elements and same on the next adjacent optical elements.

In FIG. 1, a lens array 1 of the first embodiment is a lenticular lens array. However, a fly-eye lens array (a fly-eye-shaped convex lens array) can also be used in the same manner. A transparent spacer 2 for adjusting a focal length is disposed in an input light path of the lens array 1, and a two-dimensional image 3 including a parallax information is positioned in proximity to a focal plane of the lens array 1 on an entrance side of the spacer 2.

The two-dimensional image including the parallax information is an element to make the rays from the image including different parallax information pass through the corresponding lens. The image includes two IP-images, one IP-image 4 emits a longitudinal polarized light and the other IP-image 5 emits a lateral polarized light. Of course, these polarization character choices are arbitrary. The choice of polarization is preferably orthogonal pair such as right-circular and left-circular and so on. These two IP-images are disposed alternately.

Longitudinal polarizing plates 6 and lateral polarizing plates 7 are disposed alternately on emission side of each of the lenses of the lens array 1 so that the polarization character of adjacent lenses are different and next adjacent lenses are same.

Polymethylmethacrylate so-called an acrylic resin that is used for a common plastic lens, PET so-called polyethylene terephthalate, an episulphide resin, and the like, are able to be used as a material for the lens array 1. An acrylic resin, polyethylene terephthalate, an episulphide resin, and the like, can be used as a material for the spacer 2, as in the case with the lens array 1.

The two-dimensional image 3 that is positioned in proximity to the focal plane of the lens array 1 and that includes parallax information can also be generated by use of a high-precision print or by means of a two-dimensional display device, such as liquid crystal. Moreover, the two-dimensional image can also be produced by use of a two-dimensional display device using a projection optical system, such as a projector.

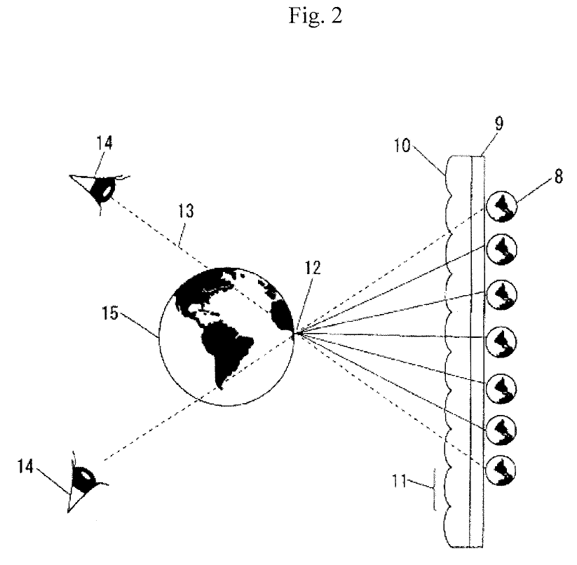

By reference to FIGS. 2 through 4, operation for preventing occurrence of crosstalk between adjacent lenses will be described hereunder. Integral photography described in (Patent Document 1) will first be described by reference to FIG. 2. FIG. 2 is a view for describing the principle of integral photography.

To begin with, integral photography proposed by M. G. Lippmann in 1908 is described.

In FIG. 2, a fly-eye lens array 10 is used for the integral photography proposed by M. G. Lippmann in 1908. The fly-eye lens array 10 is an array of a plurality of small convex lenses 11 (fly-eye lens) disposed on a sheet substrate like a compound eye of a fly.

An unillustrated film is placed at the position of a plane side focal point of the fly-eye lens array 10. The film is exposed by an object light from the lens side of the fly-eye lens array 10 so that a small object image belonging to each of the convex lenses (a reproduced element image 8 in an illustrated embodiment) are registered on the film.

A developed film is placed at the position of the focal point of the fly-eye lens array 10 and exposed to light from the back side, to thus make an observation through the fly-eye lens array 10. Thereby, a stereoscopic image (a three-dimensional reproduced image 15 exhibiting a stereoscopic effect in an illustrated embodiment) is reproduced from the small subject images generated for the respective convex lenses 11 recorded on the film.

In short, under the integral photography described in JP2001-275134, a display element 9 is placed in lieu of the film at the position of the focal point generated on the plane surface side of the fly-eye lens array 10, the reproduced element images 8 belonging to the corresponding convex lenses 11 are displayed on the display element 9, and the thus-displayed images are observed from the lens side of the fly-eye lens array 10, as shown in FIG. 2. As a result, optical paths of the reproduced element images 8 displayed on the display element 9 converge on an image formation point 12 corresponding to the position of a pixel of a surface of the original image by way of the respective convex lenses 11. The optical path further takes divergent paths like rays 13 originating from the image formation point; and enter pupils 14 of the observer. Hence, the three-dimensional reproduced image 15 exhibiting a stereoscopic effect is reproduced.

In this case, the image formation point 12 is present in a levitating fashion. Hence, even when changing a view angle or positions of the eyes, the observer can stably view the three-dimensional reproduced image 15 exhibiting a stereoscopic effect.

A general configuration of the two-dimensional image 3 including parallax information displayed and arranged in proximity to the focal plane of the lens array 1 by the display device is described below.

In general, in the stereoscopic image method, the optical paths of the two-dimensional image including parallax information 3 are spatially separated and provided so that the image for the right-eye is seen from the right-eye position and the image for the left-eye is seen from the right-eye position. In order to produce a stereographical effect, the image for the right-eye and the image for the left-eye are divided into strips as many as the number of columns of the slits or the lenticular lenses. The strips of images are rearranged so that the strip of the image for the right-eye and the strip of the image for the left-eye are disposed alternately. Then the pair of the strips of the image for the right-eye and for the left-eye is allotted to one of the slits or the lenticular lenses.

Under the ultra-multiple eye method or the integral photography, images equal in number to parallaxes are divided into short strips equal in number of slits or lenticular lens arrays. Re-positioning the parallax images divided into short strips in sequence and in the parallax direction. The parallax images equal in number to the parallaxes are grouped as a set, and the set is assigned to one slit or one lenticular lens, whereby a stereoscopic image can be reproduced. Information about a three-dimensional image comes into a three-dimensional stereoscopic image including a plurality of horizontal, vertical parallaxes upon entrance the eyes of the observer.

Usually, a two-dimensional image including parallax information assigned to one slit or one lenticular lens is allocated to a target slit or a target lenticular lens. When viewed from the front, a two-dimensional image that straightforwardly enters the slit or the lenticular lens and that includes parallax information enters the observer's eyes.

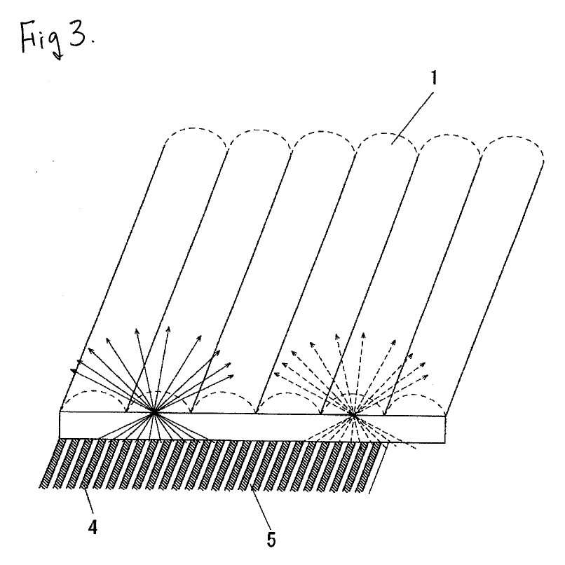

FIG. 3 is a view for describing crosstalk from an adjacent lens in the lenticular lens array. As shown in FIG. 3, when the lenticular lens are observed from an small depression angle, the two-dimensional image including parallax information allotted to the adjacent lenticular lens is inputted to the target lenticular lens. Therefore, the observer sees the image allotted to the adjacent lenticular lens through the target lenticular lens. This causes cross-talk and the image is distorted or shifted.

In order to prevent occurrence of such crosstalk, a contraption which prevent the two-dimensional image 3 allotted to the adjacent lenticular lens from entering the target lenticular lens.

However, in order to project image information from a target lenticular lens without entering the observer's eyes when observing the image from a small depression angle, it is necessary to physically project a parallax image of the low depression angle. This is, on first glance, antimony.

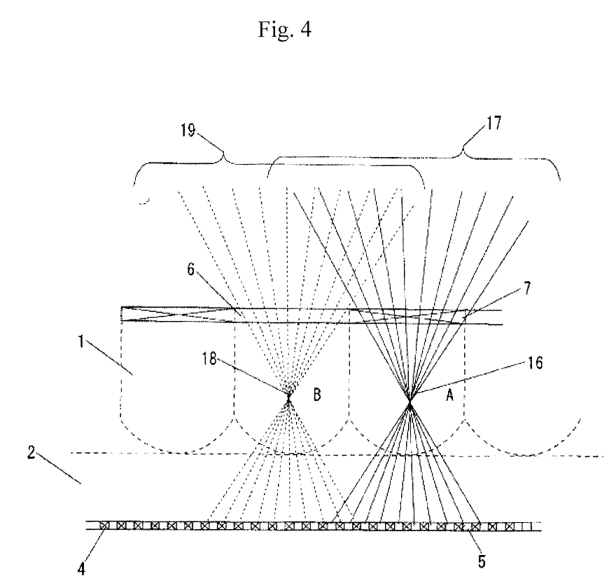

As a handling for this problem, the first embodiment aim is that a plurality of images each of which includes a right-eye image and a left-eye image as a set or a plurality of parallax images each of which includes images corresponding to each of parallaxes have alternately different polarization. In order to achieve this aim, a two dimensional image 3 formed from a longitudinally (right) polarized IP image 4 and transversely (left) polarized IP image 5. These IP images 4 and 5 are alternately arranged so as to have alternately different polarization and parallax in each of images or each of parallax images. The two dimensional image are reproduced through lens array with longitudinal polarization plate and transverse polarization plate. As a result, cross-talk is prevented by the method described in FIG. 4.

FIG. 4 is a view for describing the principle of operation for displaying a crosstalk-free image on a target lenticular lens in the three-dimensional image reproducing apparatus shown in FIG. 1. A polarization characteristic is assumed to be linearly-polarized light for the convenience of description.

In FIG. 4, provided that pictures allocated to pixels arranged so as to differ from each other in terms of polarization are a picture A and a picture B, the picture A is caused to correspond to a lenticular lens 16, and the picture B is caused to correspond to a lenticular lens 18. The lenticular lenses 16 and 18 are adjacent to each other in the lenticular lens array 1. The transverse polarizing plate 7 is affixed to an output side of the lenticular lens 16, and the longitudinal polarizing plate 6 is affixed to an output side of the lenticular lens 18.

The two-dimensional image 3 including parallax information enters respective input side of the lenticular lenses 16 and 18. In this case, since the lateral polarizing plate 7 is affixed to the output side of the lenticular lens 16, the longitudinally polarized image 4 of the two-dimensional image 3 cannot pass through the output side of the lenticular lens 16. A pixel image 17 of the picture A that can be observed at the output side of the lenticular lens 16 is merely a laterally-polarized image.

Likewise, since the longitudinal polarizing plate 6 is affixed to the output side of the lenticular lens 18, the laterally-polarized image 5 in the entered two-dimensional image 3 cannot pass through the output side of the lenticular lens 18. A pixel image 19 of the picture B that can be observed at the output side of the lenticular lens 18 is merely a longitudinally-polarized image.

As mentioned above, even when the observation is performed from a low depression angle, crosstalk between the adjacent lenticular lenses 16 and 18 can be prevented. Thus, an image that should not be originally displayed is not displayed on the adjacent lenticular lens. As a consequence, a distortion or shift of an image is prevented.

As mentioned above, according to the first embodiment, crosstalk between lenses can be prevented. Hence, an image that should not be originally displayed on an adjacent lens is not displayed, so that a distortion or shift of an image is eliminated. Therefore, a stereoscopic image becomes stable; image quality of the three-dimensional image display is enhanced; and a three-dimensional image reproducing apparatus capable of enhancing a stereoscopic effect can be embodied.

### Second Embodiment

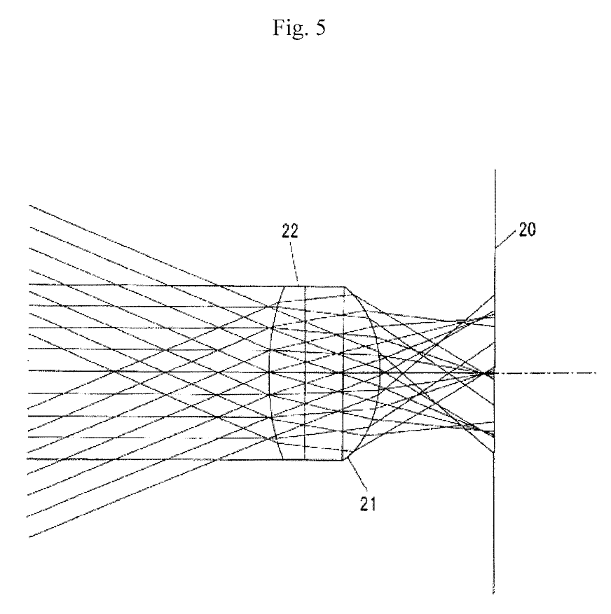

FIG. 5 is a view showing a configuration that prevents crosstalk by use of two plane-convex lenses; namely, the principal part of a three-dimensional image reproducing apparatus of a second embodiment of the present invention. The second embodiment shows an example configuration for preventing crosstalk among lenses.

As shown in FIG. 5, two plane-convex lenses 21 and 22 are configured such that convex sides are oriented to the outside. Thus, a view angle is broadened by the combination, and hence occurrence of crosstalk can be prevented.

An acrylic resin, polyethylene terephthalate, an episulphide resin, and the like, can be used as a material for the two plane-convex lenses 21 and 22. However, the following difference exists between the plane-convex lenses.

The curvature radius of the convex lens of one of the plane-convex lens 21 which is facing to the two dimensional image 20 including parallax information is smaller than that of the other plane-convex lens 22 which is facing a direction opposite to the two dimensional image 20.

In addition, the refractive index of the convex lens of one of the plane-convex lens 21 which is facing to the two dimensional image 20 including parallax information is smaller than that of the other plane-convex lens 22 which is facing a direction opposite to the two dimensional image 20.

Thus, the two-dimensional image 20 including parallax information can be placed within a target lens. Moreover, since a focal plane can be made planar, blurring of a display image, which would be caused when the depression angle is made small, can be prevented. In particular, the two plane-convex lenses 21 and 22 are made of an episulphide resin, and hence a high refractive index and greater refraction of a ray are achieved. Thus, crosstalk can be prevented more effectively.

According to the second embodiment, occurrence of crosstalk between lenses can be prevented. Hence, an image that should not be originally displayed on an adjacent lens is not displayed, and occurrence of a phenomenon of distortion or shift of an image is prevented. Therefore, there can be embodied a three-dimensional image reproducing apparatus that produces a stable stereoscopic image; that enhances image quality of a three-dimensional image display; and that can enhance a stereoscopic effect.

### Third Embodiment

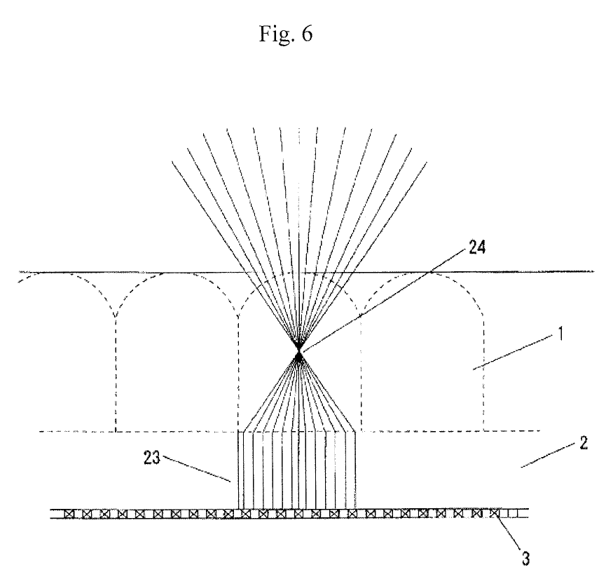

FIG. 6 is a view showing a configuration that prevents occurrence of crosstalk by use of an integrated waveguide; namely, the principal unit of a three-dimensional image reproducing apparatus of a third embodiment of the present invention. The third embodiment shows an example configuration for preventing occurrence of crosstalk between lenses.

As shown in FIG. 6, an integrated waveguide 23 is positioned in close contact with the two-dimensional image 3 including parallax information so as to direct the two dimensional image 3 to the principal point of the lens 1. Accordingly, as the adjacent lenses 1 are optically separated, crosstalk is prevented.

The integrated waveguide 23 is made of a visual field limitation film or glass fiber, thereby making it possible to more efficiently, optically separate adjacent lenses.

According to the third embodiment, occurrence of crosstalk between lenses can be prevented. Hence, an image that should not be originally displayed on an adjacent lens is not displayed, and occurrence of a phenomenon of distortion or shift of an image is prevented. Therefore, there can be embodied a three-dimensional image reproducing apparatus that produces a stable stereoscopic image; that enhances image quality of a three-dimensional image display; and that can enhance a stereoscopic effect.

### Fourth Embodiment

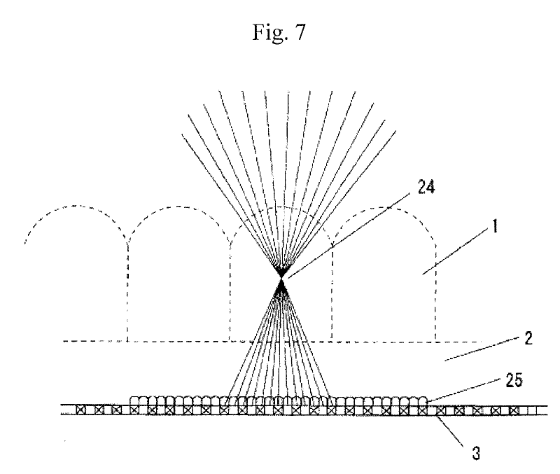

FIG. 7 is a view showing a configuration that prevents occurrence of crosstalk by use of a microlens; namely, the principal part of a three-dimensional image reproducing apparatus of a fourth embodiment of the present invention. The fourth embodiment shows an example configuration for preventing occurrence of crosstalk between lenses.

As shown in FIG. 7, microlenses 25 oriented toward the center of the lens are placed on each pixel of the two-dimensional image 3 including parallax information in close contact. These microlenses 25 guides the two-dimensional image 3 to the position of the principal point 24 of each of the lenses. Thereby, adjacent lenses are optically separated from each other, and hence occurrence of crosstalk can be prevented.

Light can be efficiently guided to the principal point 24 of the lens by forming the microlenses 25 from an episulphide resin. The microlens 25 oriented toward the center of the lens is produced on a per-pixel basis by means of screen printing, whereby a microlens having superior precision can be produced at low cost.

According to the fourth embodiment, occurrence of crosstalk between lenses can be prevented. Hence, an image that should not be originally displayed on an adjacent lens is not displayed, and occurrence of a phenomenon of distortion or shift of an image is prevented. Therefore, there can be embodied a three-dimensional image reproducing apparatus that produces a stable stereoscopic image; that enhances image quality of a three-dimensional image display; and that can enhance a stereoscopic effect.

### Fifth Embodiment

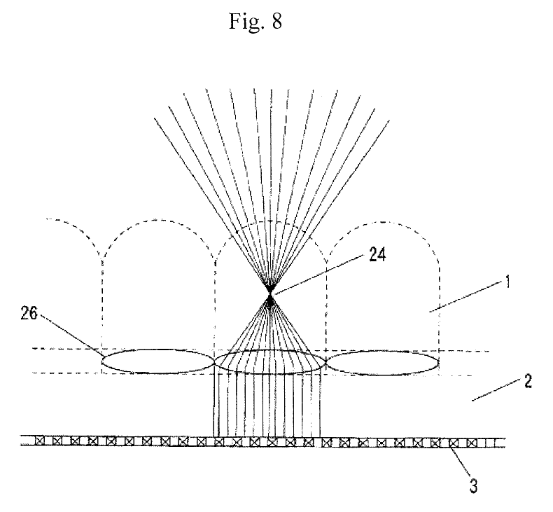

FIG. 8 is a view showing a configuration that prevents occurrence of crosstalk by placing convex lenses at entrance ends of respective lenses or optical elements; namely, the principal part of a three-dimensional image reproducing apparatus of a fifth embodiment of the present invention. The fifth embodiment shows an example configuration for preventing occurrence of crosstalk between lenses.

As shown in FIG. 8, convex lenses 26 are positioned at entrance ends of respective lenses of the lens array 1, thereby guiding the two-dimensional image 3 to the position of the principal point 24 of each of the lenses. Since adjacent lenses are thereby optically separated from each other, occurrence of cross-talk can be prevented.

According to the fifth embodiment, occurrence of crosstalk between lenses can be prevented. Hence, an image that should not be originally displayed on an adjacent lens is not displayed, and occurrence of a phenomenon of distortion or shift of an image is prevented. Therefore, there can be embodied a three-dimensional image reproducing apparatus that produces a stable stereoscopic image; that enhances image quality of a three-dimensional image display; and that can enhance a stereoscopic effect.

### Sixth Embodiment

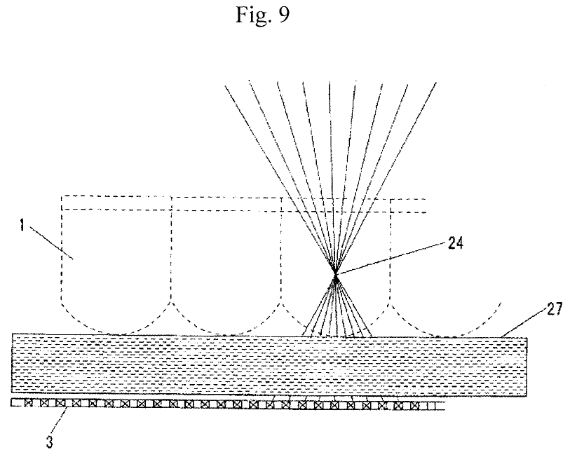

FIG. 9 is a view showing a configuration that prevents occurrence of crosstalk by placing a hologram surface in a common input optical path to a lens array or a common input optical path to all optical elements; namely, the principal unit of a three-dimensional image reproducing apparatus of a sixth embodiment of the present invention. The sixth embodiment shows an example configuration for preventing occurrence of crosstalk between lenses.

As shown in FIG. 9, a hologram plane 27 is placed in a common input optical path to the lens array 1, and the two-dimensional image 3 is guided to the position of the principal point 24 of each of the lenses. Since adjacent lenses are thereby optically separated from each other, occurrence of crosstalk can be prevented.

Further, the hologram plane 27 is embodied as a volume hologram, whereby a bright image exhibiting high refraction efficiency can be reproduced.

According to the sixth embodiment, occurrence of crosstalk between lenses can be prevented. Hence, an image that should not be originally displayed on an adjacent lens is not displayed, and occurrence of a phenomenon of distortion or shift of an image is prevented. Therefore, there can be embodied a three-dimensional image reproducing apparatus that produces a stable stereoscopic image; that enhances image quality of a three-dimensional image display; and that can enhance a stereoscopic effect.

### Seventh Embodiment

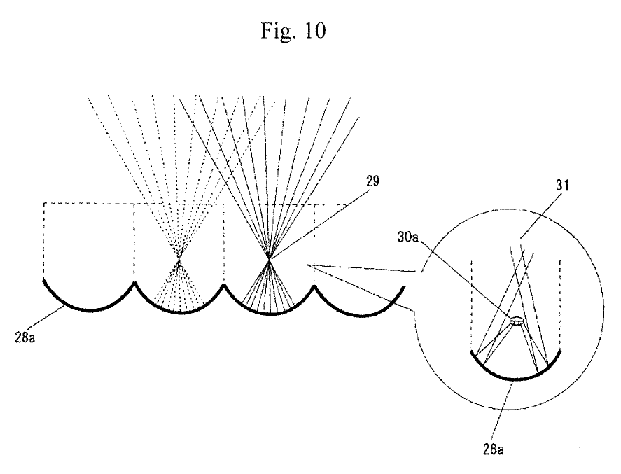

FIG. 10 is a view showing a configuration that prevents occurrence of crosstalk by placing a light source that generates light rays in equal number to parallaxes at a focal point on a quadratic surface of a sculptured surface; namely, the principal part of a three-dimensional image reproducing apparatus of a seventh embodiment of the present invention. The seventh embodiment shows an example configuration for preventing occurrence of crosstalk between lenses.

As shown in FIG. 10, there is placed a light source 30a that generates light rays in equal number to parallaxes at a focal point 29 on a quadratic surface or a sculptured surface 28a, and light is projected in a parallax direction 31, whereby a crosstalk-free stereoscopic image is obtained.

A laser light source, an LED light source, an organic LED light source, and the like, can be selected as the light source 30a.

According to the seventh embodiment, occurrence of crosstalk between lenses can be prevented. Hence, an image that should not be originally displayed on an adjacent lens is not displayed, and occurrence of a phenomenon of distortion or shift of an image is prevented. Therefore, there can be embodied a three-dimensional image reproducing apparatus that produces a stable stereoscopic image; that enhances image quality of a three-dimensional image display; and that can enhance a stereoscopic effect.

### Eighth Embodiment

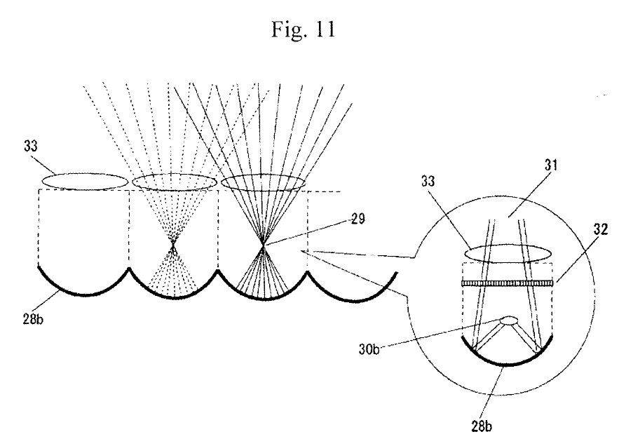

FIG. 11 is a view showing a configuration that prevents occurrence of crosstalk by provision of a transparent spatial modulator that modules light projected by a quadratic surface in a parallax direction by means of information about an image to be displayed and that allows passage of the thus-modulated light; namely, the principal part of a three-dimensional image reproducing apparatus of an eighth embodiment of the present invention. The eighth embodiment shows an example configuration for preventing occurrence of crosstalk between lenses.

As shown in FIG. 11, there are provided quadratic surfaces 28b, convex lenses 33, and light sources 30b disposed at focal points 29 of the respective quadratic surfaces 28b, and a transparent spatial modulator 32 interposed between the convex lenses 33 and the light sources 30b. The transparent spatial modulator 32 modulates, by use of image information to be displayed, light from the light sources 30b projected in a parallax direction 31 by the quadratic surfaces 28b by way of convex lenses 33 and allows passage of the thus-modulated light. Hence, a crosstalk-free stereoscopic image is projected by the convex lenses 33.

A laser light source, an LED light source, an organic LED light source, and the like, can be selected as the light source 30b. Further, transparent liquid crystal can be selected as the transparent spatial modulator 32.

According to the eighth embodiment, occurrence of crosstalk between lenses can be prevented. Hence, an image that should not be originally displayed on an adjacent lens is not displayed, and occurrence of a phenomenon of distortion or shift of an image is prevented. Therefore, there can be embodied a three-dimensional image reproducing apparatus that produces a stable stereoscopic image; that enhances image quality of a three-dimensional image display; and that can enhance a stereoscopic effect.

### Ninth Embodiment

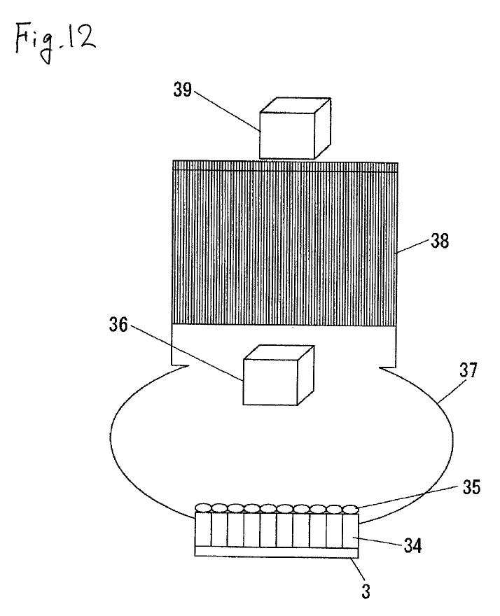

FIG. 12 is a view showing a configuration that prevents occurrence of crosstalk by use of a relay optical system that spatially projects an image once formed by an optical system; namely, the principal part of a three-dimensional image reproducing apparatus of a ninth embodiment of the present invention. The ninth embodiment shows an example configuration for preventing occurrence of crosstalk between lenses.

As shown in FIG. 12, the two-dimensional image 3 including parallax information is once formed into a stereoscopic image 36 by means of a projection optical system 35 including convex lenses 34. Further, the stereoscopic image 36 is again projected by a parabolic mirror 37, and the image is spatially projected by use of a relay optical system 38 using an optical fiber, an optical rod, and the like, thereby reproducing a stereoscopic image 39 that is less likely to generate crosstalk.

In FIG. 12, the stereoscopic image 36 reproduced by the parabolic mirror 37 is again reproduced as a stereoscopic image 39 at the position of the reproduced image by use of the relay optical system 38.

According to the ninth embodiment, occurrence of crosstalk between lenses can be prevented. Hence, an image that should not be originally displayed on an adjacent lens is not displayed, and occurrence of a phenomenon of distortion or shift of an image is prevented. Therefore, there can be embodied a three-dimensional image reproducing apparatus that produces a stable stereoscopic image; that enhances image quality of a three-dimensional image display; and that can enhance a stereoscopic effect. The optical rod is preferably a refractive index distributed type rod lens.

As mentioned above, the three-dimensional image reproducing apparatus of the present invention is effective for realizing a stable three-dimensional image display when a stereoscopic image is reproduced by use of a lenticular lens array, a fly-eye lens array, or a hologram optical element, by preventing occurrence of crosstalk between adjacent lenses or adjacent hologram optical elements, to thus eliminate a shift of the three-dimensional image. In particular, the three-dimensional image reproducing apparatus is suitable for use in fields of imaging technology, amusement, entertainment, the Internet, information, multimedia, communication, advertisement, medical treatment, art, education, design support, simulation, virtual reality, and the like.

What is claimed is:

1. A three-dimensional image reproduce apparatus comprising:
an array of adjacent optical elements, which is an array of lenticular lens, an fly-eye lens array or an array of hologram optical elements;
a cross-talk prevent part preventing cross-talk between the adjacent optical elements, and having an image source providing a plurality of images each of which has a different parallax information.

2. The image reproduce apparatus according to claim 1, wherein the cross-talk prevent part comprises:
the plurality of images provided by the image source and on a focus plane of the array so that a polarized characters of a ray from each of the images are different from each other in order that the ray passes through corresponding one of the optical elements; and
a polarizing plate provided on an emitting side of the optical elements and having a polarized character which is different on the adjacent optical elements and same on the next adjacent optical elements.

3. The image reproduce apparatus according to claim 2, wherein the polarized characters are transverse and longitudinal polarization.

4. The image reproduce apparatus according to claim 2, wherein the polarized characters are right-circular and left-circular polarization.

5. The image reproduce apparatus according to claim 1, wherein the cross-talk prevent part comprises:
a first plane-convex lens and a second plane-convex lens wherein the first and the second plane-convex lenses are combined so as to direct a convex side of each of the plane-convex lenses to outside.

6. The image reproduce apparatus according to claim 5, wherein the convex surface of the first plane-convex lens faces to the images; and
a curvature radius of the first plane-convex lens is smaller than that of the second plane-convex lens.

7. The image reproduce apparatus according to claim 5, wherein the convex surface of the first plane-convex lens faces to the images; and
a refraction index of the first plane-convex lens is smaller than that of the second plane-convex lens.

8. The image reproduce apparatus according to claim 5, wherein the first and the second plane-convex lens are made from episulfide resin.

9. The image reproduce apparatus according to claim 1, wherein the cross-talk prevent part comprises:
the plurality of images provided by the image source; and
a wave guide closely-attached to the images so as to optically separate the adjacent optical elements by directing rays from the images to a principal point of lenses.

10. The image reproduce apparatus according to claim 9, wherein the wave guide is formed from a eyesight restriction film.

11. The image reproduce apparatus according to claim 9, wherein the wave guide is formed from a glass fiber.

12. The image reproduce apparatus according to claim 1, wherein the cross-talk prevent part comprises a plurality of micro-lenses provided on each pixel of the images to be reproduced.

13. The image reproduce apparatus according to claim 12, wherein the micro lenses are formed from episulfide resin.

14. The image reproduce apparatus according to claim 12, wherein the micro lenses are formed by screen print.

15. The image reproduce apparatus according to claim 1, wherein the cross-talk prevent part comprises a plurality of convex lenses each of which are provided on an input optical path of each of the optical elements.

16. The image reproduce apparatus according to claim 15, wherein the focal point of each of the convex lenses coincides with the principal point of respective one of the optical elements.

17. The image reproduce apparatus according to claim 1, wherein the cross-talk prevent part comprises a hologram surface provided on a common input optical path of the array.

18. The image reproduce apparatus according to claim 17, wherein the focal point of the hologram surface is coincide with the principal point of the optical elements.

19. The image reproduce apparatus according to claim 17, wherein the hologram surface is a volume hologram.

20. The image reproduce apparatus according to claim 1, wherein the image source has a light source provided on a focal point of a quadratic curve or free curve so as to emit rays same in number as a parallax number to parallax direction.

21. The image reproduce apparatus according to claim 20, wherein the light source is a laser.

22. The image reproduce apparatus according to claim 20, wherein the light source is a LED.

23. The image reproduce apparatus according to claim 20, wherein the light source is an organic LED.

24. The image reproduce apparatus according to claim 1, wherein the cross-talk prevent part comprises:
a convex lens;
a quadratic curve projecting a ray into a parallax direction, wherein the ray is emitted from a light source provided on a focal point of the quadratic curve;
a translucent type spatial modulator provided between the convex lens and the light source and modulating the projected ray.

25. The image reproduce apparatus according to claim 24, wherein the light source is a laser.

26. The image reproduce apparatus according to claim 24, wherein the light source is a LED.

27. The image reproduce apparatus according to claim 24, wherein the light source is an organic LED.

28. The image reproduce apparatus according to claim 24, wherein the spatial modulator is formed from a translucent type liquid crystal.

29. The image reproduce apparatus according to claim 1, wherein the cross-talk prevent part comprises a relay optical system projecting an image once reproduced by another optical system by a parabola surface, optical fiber and optical rod.

30. The image reproduce apparatus according to claim 29, wherein the optical rod is a refractive index distributed type rod lens.
